(19) United States
(12) Patent Application Publication
(10) Pub. No.: US 2026/0299208 A1
(43) Pub. Date: Oct. 1, 2026

(54) INTEGRATED PHOTONIC 2X3 COUPLER

(71) Applicant: Cisco Technology, Inc., San Jose, CA (US)

(72) Inventors: Jonathan Edgar ROTH, San Mateo, CA (US); Qianfan XU, Houston, TX (US); Long CHEN, Marlboro, NJ (US)

(21) Appl. No.: 19/704,175

(22) Filed: Jun. 10, 2026

Related U.S. Application Data
(62) Division of application No. 18/325,909, filed on May 30, 2023, now Pat. No. 12,693,475.

(51) Int. Cl. G02B 6/293; G02B 6/12; G02B 6/122; G02B 6/126; G02B 6/136; G02B 6/27; G02B 6/28; G02F 1/21; G02F 1/225; G02F 1/313

(52) U.S. Cl. CPC G02B 6/29355; G02B 6/1228; G02B 6/126; G02B 6/274; G02B 6/2773; G02B 6/2821; G02B 6/29344; G02B 6/29395; G02F 1/212; G02F 1/225; G02F 1/3132; G02B 2006/12097; G02B 2006/12147; G02B 6/136

(57) ABSTRACT

Disclosed is an adiabatic optical coupler. The adiabatic optical coupler includes a tapered input region which includes a first waveguide core and a second waveguide core. The first and second waveguide cores are separated at the tapered input region. The adiabatic optical coupler also includes a narrow coupling region extending from the tapered input region. In the narrow coupling region, the first and second waveguide cores are brought within close proximity and a third waveguide core is positioned between the first and second waveguide cores. The third waveguide core defines a longitudinal axis. The adiabatic optical coupler also includes a flared output region extending from the narrow coupling region. In the flared output region, the first, second, and third waveguide cores are separated.

### CROSS-REFERENCE TO RELATED APPLICATIONS

This application is a divisional of co-pending U.S. patent application Ser. No. 18/325,909 filed May 30, 2023. The aforementioned related patent application is herein incorporated by reference in its entirety.

### FIELD

This disclosure relates generally to the field of photonic systems and more particularly relates to an integrated photonic 2×3 coupler for use within a tunable optical filter (TOF), such as the one manufactured by Acacia.

### BACKGROUND

Contemporary optical communications and other photonic systems make extensive use of photonic integrated circuits that are advantageously mass-produced in various configurations for various purposes. One of the components typically used in photonic integrated circuits are referred to herein as couplers, or splitters. These may have a number of configurations, although the present disclosure often references 1×2, 2×2, and 2×3 configurations, wherein a 2×2 coupler comprises a single input and two outputs and wherein a 2×2 coupler comprises two inputs and two outputs, and so on. In a general sense, these couplers, or splitters, are used between cascaded Mach Zehnder Interferometer (MZI) filter stages to construct a tunable optical filter (TOF) system. In should be noted that the terms “MZI filter” and “tunable optical filter” may be used interchangeably herein and are to be understood as referencing the same system.

One of the largest problems stemming from the use of conventional couplers, or splitters, is the significant area that they require on a chip. A conventional pair of 2×2 couplers is typically around 920 microns in length, which requires a significant amount of space on a chip. Additionally, a long propagation length within a photonic integrated circuit increases the attenuation of an optical signal relative to attenuation over a shorter propagation length. One alternative method for attempting to reduce the area as required by a conventional pair of 2×2 couplers is to fold an MZI filter stage, however, this results in an uncertainty in targeting the path length difference in each MZI filter stage, as well as increased attenuation due to increased propagation length. Thus, the present disclosure takes a new approach which merges a combiner, a drop port (or, alternatively, a monitor photodiode), and a splitter into one 2×3 coupler that is expected to reduce the required area by two to three times.

### SUMMARY

In part, in one aspect, the disclosure relates to an adiabatic optical coupler, comprising a tapered input region comprising a first waveguide core and a second waveguide core separated by a distance; a narrow coupling region extending from the tapered input region, wherein the first waveguide core and the second waveguide core are brought into close proximity, and wherein a third waveguide core is positioned between the first waveguide core and the second waveguide core, the third waveguide core defining a longitudinal axis; and a flared output region extending from the narrow coupling region, wherein the first waveguide core, the second waveguide core, and the third waveguide core are separated.

In one aspect of the adiabatic optical coupler, light entering the first waveguide core and the second waveguide core at the tapered input region comprises a TE0 mode (in-phase) component and a TE1 mode (out-of-phase) component.

In one aspect of the adiabatic optical coupler, the TE0 mode (in-phase) component is routed to the third waveguide core, and the TE1 mode (out-of-phase) component remains on the first waveguide core and the second waveguide core.

In one aspect of the adiabatic optical coupler, in the narrow coupling region, power in the TE0 mode peaks along the longitudinal axis aligning with the third waveguide core, and power in the TE1 mode has a null along the longitudinal axis aligning with the third waveguide core and has two peaks above and below the longitudinal axis aligning with the first waveguide core and the second waveguide core.

In one aspect of the adiabatic optical coupler, the tapered input region, the narrow coupling region, and the flared output region are symmetric about the longitudinal axis.

In one aspect of the adiabatic optical coupler, the third waveguide core widens as it extends from the narrow coupling region to the flared output region.

In one aspect of the adiabatic optical coupler, the first waveguide core is a rib surrounded by a first slab portion and the second waveguide core is a rib surrounded by a second slab portion at the tapered input region; the first waveguide core, the second waveguide core, and the third waveguide core are ribs surrounded by a single slab portion at the narrow coupling region; and the first waveguide core is a rib surrounded by a first slab portion, the second waveguide core is a rib surrounded by a second slab portion, and the third waveguide core is a rib surrounded by a third slab portion at the flared output region.

In part, in one aspect, the disclosure relates to a multimode interference optical coupler, comprising a tapered input region comprising a first input waveguide core and a second input waveguide core separated by a distance; an interference propagation region extending from the tapered input region; and a flared output region extending from the interference propagation region; wherein the interference propagation region acts as a multimode waveguide core to combine light from the first input waveguide core and the second input waveguide core; and wherein the flared output region comprises a plurality of output waveguides comprising a first output waveguide core, a second output waveguide core, and a third output waveguide core; wherein the third output waveguide core defines a longitudinal axis; and wherein the interference propagation region has a length calculated to efficiently couple the light from the multimode waveguide core into the first output waveguide core, the second output waveguide core, and the third output waveguide core.

In one aspect of the multimode interference optical coupler, the interference propagation region has a length defined by 3L_{π}/8, wherein L_{π} is a beat length of two lowest order modes.

In one aspect of the multimode interference optical coupler, the first output waveguide core and the third output waveguide core are separated by a width defined by Wₑ/4, wherein Wₑ is an effective width of the interference propagation region, the third output waveguide core and the second output waveguide core are separated by a width defined by Wₑ/4, and the first input waveguide core and the second input waveguide core are separated by a width defined by Wₑ/2.

In one aspect of the multimode interference optical coupler, the first input waveguide core and the second input waveguide core are single-mode inputs, the interference propagation region comprises a multimode interference pattern, and the first output waveguide core, the second output waveguide core, and the third output waveguide core are single-mode outputs.

In one aspect of the multimode interference optical coupler, a decoupling region is positioned between the interference propagation region and the flared output region to adiabatically separate spatially overlapping output modes.

In one aspect of the multimode interference optical coupler, the tapered input region, the interference propagation region, and the flared output region are symmetric about the longitudinal axis.

In part, in one aspect, the disclosure relates to a tunable optical filter system, comprising a system input; a 1×2 input coupler, wherein the 1×2 input coupler receives light from the system input and splits the light into a first system input and a second system input; a plurality of Mach-Zehnder interferometer (MZI) filter stages cascaded in series, each MZI filter stage comprising: a first path comprising a first path length; a second path comprising a second path length, wherein the second path length is greater than the first path length; and a 2×3 interferometer, wherein the 2×3 interferometer receives light from a first input and a second input, combines the light from the first input and the second input interferometrically into an in-phase combination and an out-of-phase combination, and outputs half of the out-of-phase combination to a first output, the other half of the out-of-phase combination to a second output, and the in-phase combination to a third output; wherein, a first MZI filter stage, the first path receives light from the first system input and the second path receives light from the second system input, and wherein, any MZI filter stage subsequent to the first MZI filter stage, the first path receives light from the first output of a preceding MZI filter stage and the second path receives light from the second output of the preceding MZI filter stage; and a system output, wherein the system output comprises the first output, the second output, and the third output of a final MZI filter stage.

In one aspect of the tunable optical filter system, the 2×3 interferometer is an adiabatic optical coupler, comprising a tapered input region comprising a first waveguide core and a second waveguide core separated by a distance; a narrow coupling region extending from the tapered input region, wherein the first waveguide core and the second waveguide core are brought into close proximity, and wherein a third waveguide core is positioned between the first waveguide core and the second waveguide core, the third waveguide core defining a longitudinal axis; and a flared output region extending from the narrow coupling region, wherein the first waveguide core, the second waveguide core, and the third waveguide core are separated.

In one aspect of the tunable optical filter system, the 2×3 interferometer is a multimode interference optical coupler, comprising a tapered input region comprising a first input waveguide core and a second input waveguide core separated by a distance; an interference propagation region extending from the tapered input region; and a flared output region extending from the interference propagation region; wherein the interference propagation region acts as a multimode waveguide core to combine light from the first input waveguide core and the second input waveguide core; wherein the flared output region comprises a plurality of output waveguides comprising a first output waveguide core, a second output waveguide core, and a third output waveguide core; wherein the third output waveguide core defines a longitudinal axis; and wherein the interference propagation region has a length calculated to efficiently couple the light from the multimode waveguide core into the first output waveguide core, the second output waveguide core, and the third output waveguide core.

In one aspect of the tunable optical filter system, the tunable optical filter further comprises at least one of a first phase shifter positioned over the first path and a second phase shifter positioned over the second path.

In one aspect of the tunable optical filter system, the third output transmits light to a monitor photodiode, wherein the monitor photodiode is used to monitor and control phases of the transmitted light.

In one aspect of the tunable optical filter system, a plurality of electrical contact pads are positioned in close proximity to the plurality of MZI filter stages cascaded in series.

In one aspect of the tunable optical filter system, the plurality of MZI filter stages cascaded in series further comprise 90-degree bends to reduce a required area on a chip.

Although, the disclosure relates to different aspects and embodiments, it is understood that the different aspects and embodiments disclosed herein can be integrated, combined, or used together as a combination system, or in part, as separate components, devices, and systems, as appropriate. Thus, each embodiment disclosed herein can be incorporated in each of the aspects to varying degrees as appropriate for a given implementation. Further, the various apparatus, optical elements, passivation coatings/layers, optical paths, waveguides, splitters, couplers, combiners, electro-optical devices, inputs, outputs, ports, channels, components and parts of the foregoing disclosed herein can be used comprising laser, laser-based communication system, waveguide, fiber, transmitter, transceiver, receiver, and other devices and systems without limitation.

These and other features of the applicant's teachings are set forth herein.

### BRIEF DESCRIPTION OF THE FIGURES

Unless specified otherwise, the accompanying drawings illustrate aspects of the innovations described herein. Referring to the drawings, wherein like numerals refer to like parts throughout the several views and this specification, several embodiments of presently disclosed principles are illustrated by way of example, and not by way of limitation. The drawings are not intended to be to scale. A more complete understanding of the disclosure may be realized by reference to the accompanying drawings in which:

FIG. 1 is a schematic diagram of a single MZI filter stage.

FIG. 2 is a schematic diagram of multiple cascaded MZI filter stages.

FIG. 3 is a schematic diagram showing a silicon photonics implementation.

FIG. 4 is a plot showing the individual transmission of seven cascaded MZI filter stages.

FIG. 5 is a plot showing the overall transmission of a seven-stage MZI filter.

FIG. 6 is a schematic diagram of two cascaded MZI filter stages in a silicon photonic integrated circuit (PIC).

FIG. 7 is a schematic diagram showing a conventional tunable optical filter (TOF) system from a PIC.

FIG. 8 is a schematic diagram showing two cascaded MZI filter stages in a silicon PIC and identifies the components that will be merged into a single component.

FIG. 9 is a schematic diagram showing the disclosed invention, a 2×3 interferometer.

FIG. 10 is a schematic diagram showing a conventional 2×1 multimode interferometer (MMI).

FIG. 11 is an image showing the power density of two in-phase, equal-power inputs from the left of a conventional 2×1 MMI.

FIG. 12 is an image showing the power density for two 180°-shifted, equal-power inputs from the left of a conventional 2×1 MMI.

FIG. 13 is a schematic diagram showing one aspect of the disclosed invention, a 2×3 MMI.

FIG. 14 is a schematic diagram showing one aspect of the disclosed invention, an adiabatic 2×3 coupler.

FIG. 14A is a schematic diagram showing a magnified view of a coupling region of an adiabatic 2×3 coupler.

FIG. 15A is a schematic diagram showing the two input waveguides of a 2×3 interferometer. FIG. 15B is a schematic diagram showing the three outputs of a 2×3 interferometer.

FIG. 16A is a schematic diagram that shows the TE1 mode (out-of-phase component) at the inputs of a 2×3 interferometer. FIG. 16B is a schematic diagram that shows the TE1 mode (out-of-phase component) at the outputs of a 2×3 interferometer.

FIG. 17A is a schematic diagram that shows the TE0 mode (in-phase component) at the inputs of a 2×3 interferometer. FIG. 17B is a schematic diagram that shows the TE0 mode (in-phase component) at the outputs of a 2×3 interferometer.

FIG. 18 is a schematic diagram showing an example TE0 mode in a coupling region of a 2×3 interferometer.

FIG. 19 is a schematic diagram showing an example TE1 mode in a coupling region of a 2×3 interferometer.

FIG. 20 is a schematic diagram showing an adiabatic 2×3 coupler wherein the center waveguide begins narrow at the left and widens to the right and wherein the outer waveguides begin wide at the left, narrow in the middle region, and widen to the right, according to at least one embodiment of the present disclosure.

FIG. 21 is a schematic diagram showing an adiabatic 2×3 coupler wherein the center waveguide begins narrow at the left and widens to the right and wherein the outer waveguides begin wide at the left, narrow in the middle region, and remain narrow to the right, according to at least one embodiment of the present disclosure.

FIG. 22 is a schematic diagram showing an adiabatic 2×3 coupler wherein the center waveguide begins narrow at the left and widens to the right and wherein the outer waveguides begin narrow at the left, remain narrow in the middle region, and widen to the right, according to at least one embodiment of the present disclosure.

FIG. 23 is a schematic diagram showing an adiabatic 2×3 coupler wherein the center waveguide begins narrow at the left and widens to the right and wherein the outer waveguides begin narrow at the left, widen in the middle region, and narrow to the right, according to at least one embodiment of the present disclosure.

FIG. 24 is a schematic diagram showing an adiabatic 2×3 coupler wherein the center waveguide begins narrow at the left and widens to the right and wherein the outer waveguides begin narrow at the left, widen in the middle region, and remain widened to the right, according to at least one embodiment of the present disclosure.

FIG. 25 is a schematic diagram showing an adiabatic 2×3 coupler wherein the center waveguide begins narrow at the left and widens to the right and wherein the outer waveguides begin wide at the left, remain wide in the middle region, and narrow to the right, according to at least one embodiment of the present disclosure.

FIG. 26 is a schematic diagram showing an adiabatic 2×3 coupler wherein the center waveguide begins narrow at the left and widens to the right and wherein the outer waveguides remain uniform from left to right, according to at least one embodiment of the present disclosure.

FIG. 27 is a schematic diagram showing the implementation of 2×3 interferometers, among other components, in a seven-stage MZI filter on a PIC.

### DETAILED DESCRIPTION

This disclosure generally relates to 2×3 interferometers that merge the combiner, drop port, and splitter of an MZI filter stage into a single component in order to reduce the area required on a chip and to reduce the currently-required extra propagation length.

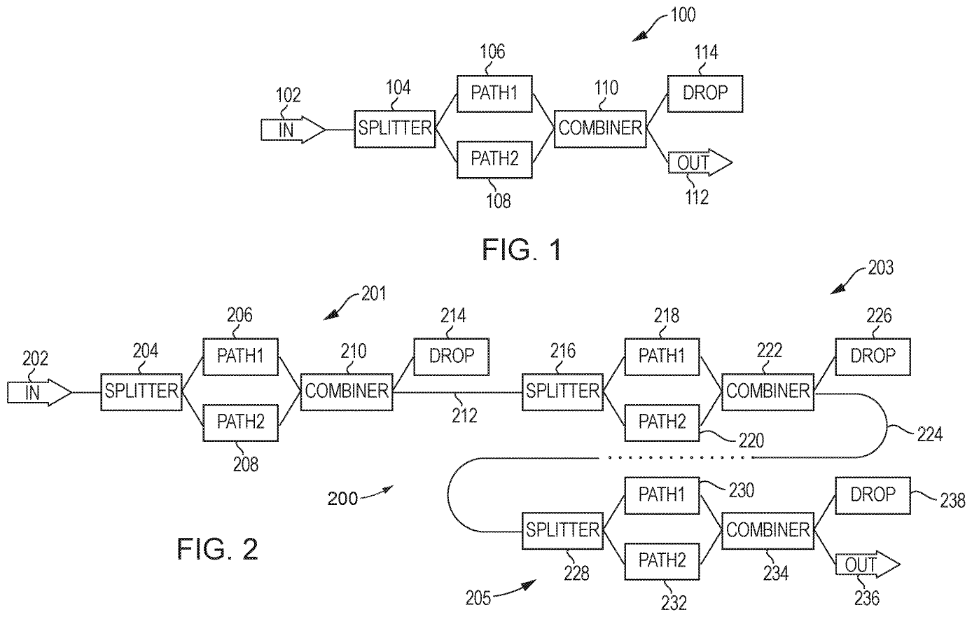

With reference now to the figures, FIG. 1 is a schematic diagram of a single MZI filter stage 100 that may be cascaded together with several other MZI filter stages. In this case, light enters the MZI filter stage 100 via input 102. Following the input 102, splitter 104 splits the light into two paths, PATH1 106 and PATH2 108, where the light is propagated a different distance along the two paths. The light is then recombined interferometrically via combiner 110. Finally, the MZI filter stage 100 separates the in-phase combination and the out-of-phase combination of the two paths. One will be outputted via output 112 as the input to the next MZI filter stage. The other is dropped via drop 114, or may, alternatively, be sent to a monitor photodiode.

FIG. 2 is a schematic diagram of a system 200 including multiple cascaded MZI filter stages 201, 203, and 205. Light enters the system 200 via input 202. Following the input 202, splitter 204 splits the light into two paths, PATH1 206 and PATH2 208, where the light is propagated a different distance along the two paths. The light is then recombined interferometrically via combiner 210. Finally, MZI filter stage 201 separates the in-phase combination and the out-of-phase combination of the two paths. One is output as the input to MZI filter stage 203 via line 212. The other is dropped via drop 214, or may, alternatively, be sent to a monitor photodiode. The light then travels into splitter 216 where it is split into two paths, PATH1 218 and PATH2 220, and where it is propagated a different distance along the two paths. The light is then recombined interferometrically via combiner 222. Finally, MZI filter stage 203 separates the in-phase and out-of-phase combination of the two paths. One is output as the input to MZI filter stage 205 via line 224. The other is dropped via drop 226, or may, alternatively, be sent to a monitor photodiode. The light then travels into splitter 228 where it is split into two paths, PATH1 230 and PATH2 232, and where it is propagated a different distance along the two paths. The light is then recombined interferometrically via combiner 234. Finally, MZI filter stage 205 separates the in-phase combination and out-of-phase combination of the two paths. One is output via output 236 as the input to the next MZI filter stage. The other is dropped via drop 238, or may alternatively be sent to a monitor photodiode.

It should be noted that FIGS. 1 and 2 are simply representations of the elements that MZI filter stages comprise and how multiple MZI filter stages are cascaded to construct a tunable optical filter. FIGS. 1 and 2 should not, in any way, be construed as limiting the number of MZI filter stages per tunable optical filter to one or three, respectively. Furthermore, it should be noted that inputs 102 and 202 are not necessarily the first input of their respective tunable optical filters, and outputs 112 and 236 are not necessarily the last output of their respective tunable optical filters.

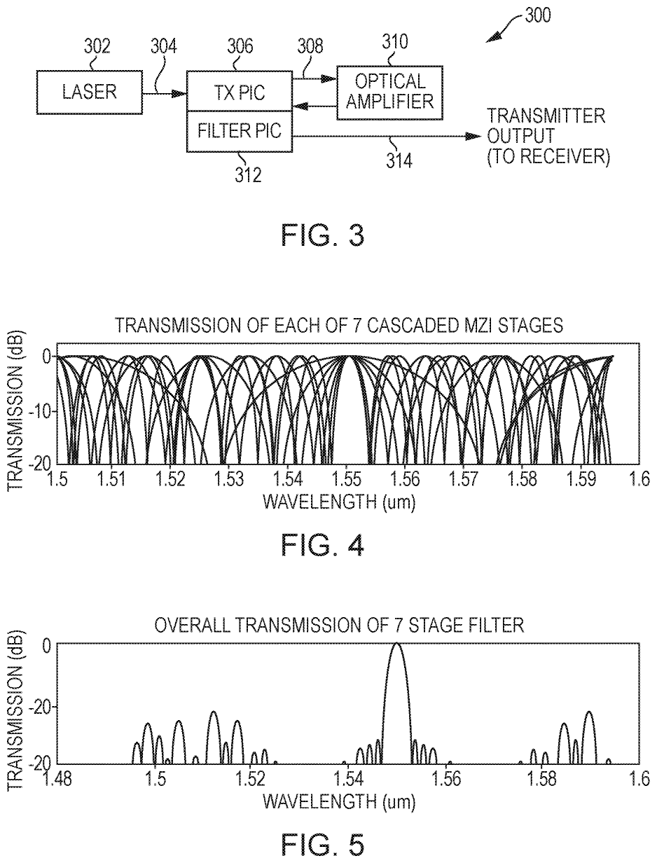

FIG. 3 is a schematic diagram showing a silicon photonics implementation 300 wherein the light generation and amplification is off-chip. The laser 302 generates optical carrier 304 which is transmitted to transmitter PIC 306, also referred to herein as TX PIC 306. The transmitter PIC 306 then modulates the optical carrier 304 and generates an optical signal 308. An optical amplifier 310 then amplifies the optical signal 308 and introduces spontaneous emission noise. Finally, a tunable optical filter 312, which may be on the same PIC, removes out-of-band noise and cleans up the optical signal 308 before transmitting an output 314.

FIG. 4 is a plot showing the individual transmission of seven cascaded MZI filter stages. FIG. 5 is a plot showing the overall transmission of a seven-stage MZI filter. In both FIGS. 4 and 5, each stage of the MZI filter has a different delay between two paths due to different path lengths in each MZI filter stage. Furthermore, monitoring the MZI filter and gathering optical feedback is used to tune the relative phase of the two paths at each MZI filter stage.

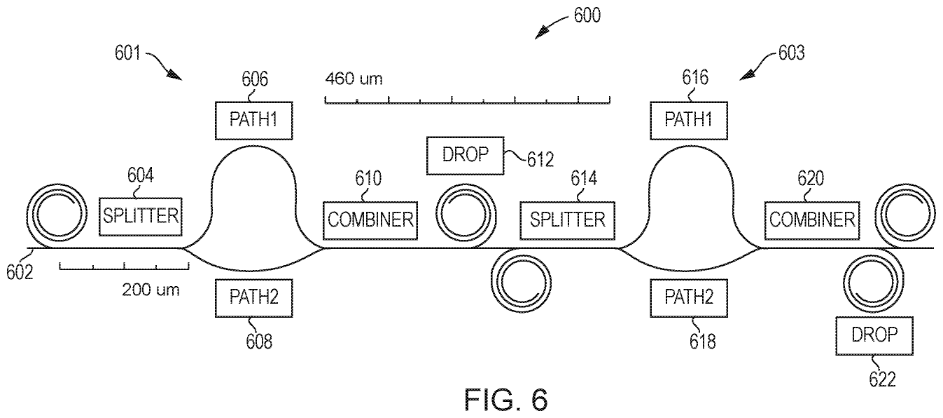

FIG. 6 is a schematic diagram showing two stages, 601 and 603, of an MZI filter 600 in a silicon photonic integrated circuit (PIC). Light enters the first stage 601 via input 602. Following the input 602, splitter 604 splits the light into two paths, PATH1 606 and PATH2 608, where the light is propagated a different distance along the two paths. The light is then recombined interferometrically via combiner 610. Finally, the first stage 601 separates the in-phase combination and the out-of-phase combination of the two paths. One is output as the input to the second stage 603. The other is dropped via drop 612, or may, alternatively, be sent to a monitor photodiode. The light then travels into splitter 614 where it is split into two paths, PATH1 616 and PATH2 618, where it is propagated a different distance along the two paths. The light is then recombined interferometrically via combiner 620. Finally, the second stage 603 separates the in-phase combination and the out-of-phase combination of the two paths. One is output as the input to the next MZI filter stage. The other is dropped via drop 622, or may, alternatively, be sent to a monitor photodiode.

It should be noted that FIG. 6 is simply a representation of how multiple MZI filter stages are cascaded to construct an optical filter and should not be construed as limiting the number of MZI filter stages per optical filter to two. Furthermore, it should be noted that the input of MZI filter stage 601 is not necessarily the first input of the tunable optical filter, and the output of MZI filter stage 603 is not necessarily the last output of the tunable optical filter.

Additionally, it should be noted that when constructing a tunable optical filter comprising several cascaded MZI filter stages, the different MZI filter stages may be reordered or rearranged without changing the functionality of the tunable optical filter. For example, with regard to FIG. 6, conventional stages 601 and 603 may swap positions in the MZI filter 600 and the overall functionality will remain the same. This concept applies to the various other tunable optical filters, or MZI filters, shown and discussed herein the present disclosure.

In the above disclosed FIG. 6, the splitters, 604 and 614, and the combiners, 610 and 620, are adiabatic components which are used in optical communications for low loss, low back reflection, fabrication tolerance, and wide bandwidth advantages. Furthermore, in the above disclosed FIG. 6, the splitters, 604 and 614, and the combiners, 610 and 620, are the same design of an adiabatic 2×2 coupler. Lastly, it should be noted that phase shifters, which are placed over at least one of the two paths in each stage, are not shown in FIG. 6.

Furthermore, in the above disclosed FIG. 6, several rulers are provided to indicate the length, in microns (i.e., um), of the above identified components. Most notably, the center ruler discloses that the combiner 610, drop 612, and splitter 614 total a length of 458.82 um. This is the length of one 2×2 coupler. However, in conventional uses, two 2×2 couplers are used in a row, totaling a combined length of nearly 920 um. As a result, a significant amount of area is required on a chip for these pairs of 2×2 couplers. The present disclosure provides a solution by way of the disclosed invention.

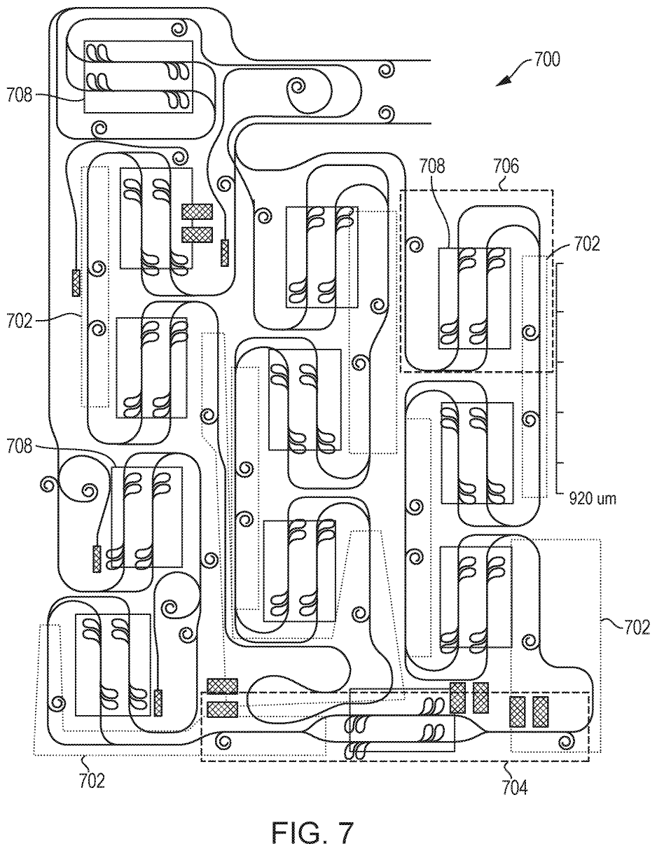

FIG. 7 is a schematic diagram showing a tunable optical filter (TOF) 700 from a PIC. This TOF comprises several different elements, though namely pairs of 2×2 couplers 702 that are between cascaded MZI filters, such as those identified by the dashed box 704 and dashed box 706, wherein dashed box 704 is an MZI filter in a straight configuration and wherein dashed box 706 is an MZI filter in a folded configuration. The pairs of 2×2 couplers 702 can be replaced with the disclosed invention. FIG. 7 further comprises interferometer arms 708 which contain thermo-optic phase shifters (TOPS) used to tune the TOF 700. The above-disclosed 2×2 couplers 702 are long and require a significant amount of space, increasing the total area required for the chip and increasing attenuation of the signal associated with increased propagation length. A folded configuration, as disclosed by dashed box 706, helps to save space, however this lengthens the interferometer arms 708 which further increases the uncertainty in targeting the path length difference between the arms in each MZI filter stage and further increases attenuation of the signal associated with increased propagation length. The disclosed invention provides a solution by merging the combiner, drop port, and splitter into one component which will greatly reduce the area required on the chip. That is, in the TOF application, a presently disclosed 2×3 interferometer that is 115 microns long will replace two 2×2 couplers which have a combined length around 920 microns. The disclosed invention also allows for the separation of the in-phase and out-of-phase components along separate paths in each MZI filter stage. Finally, the disclosed invention also allows for 50/50 splitting of the out-of-phase component into two separate outputs.

It should be noted that there are several pairs of 2×2 couplers 702 and interferometer arms 708 found within the TOF 700 despite only a few having been identified by like numerals. The pairs of 2×2 splitters are generally identified by a dotted box similar to those already labeled “702”. The pairs of interferometer arms 708 are generally identified by a solid box similar to those already labeled “708”. Furthermore, this TOF 700 comprises several folded configurations despite only one having been identified. The others are not similarly identified by the dashed box 706, however, one having ordinary skill in the art would be able to easily identify the folded configurations that occur throughout this PIC.

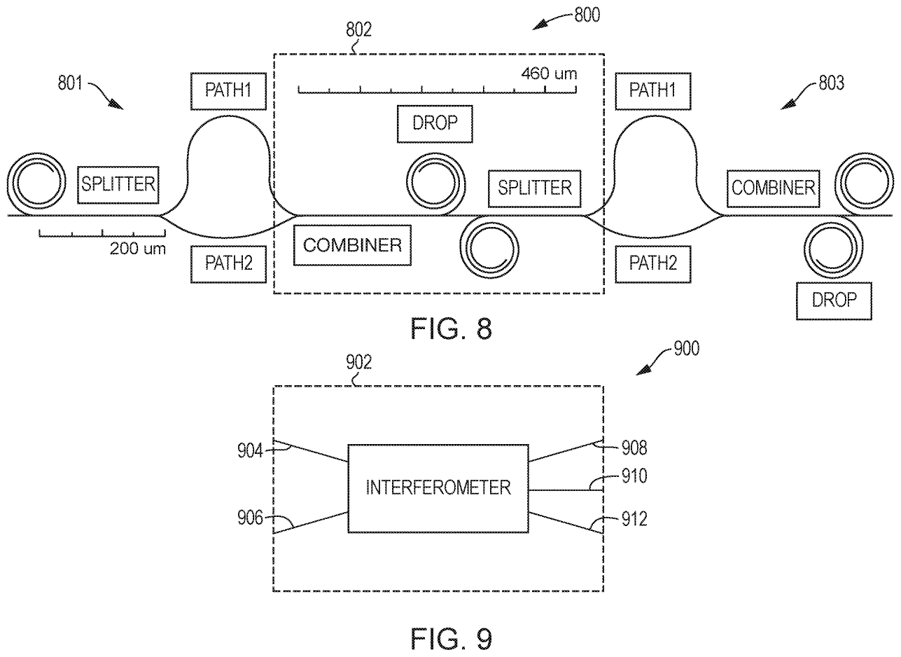

FIG. 8 is a schematic diagram showing two stages, 801 and 803, of an MZI filter 800 in a silicon PIC and outlines, by the dashed box 802, the components that will be merged together. The components and disclosure of FIG. 8 are substantially the same as those disclosed in FIG. 6 and Paragraphs [0061]-[0065], above. The only difference between these two figures is the identification of the components to be merged as outlined by dashed box 802.

FIG. 9 is a schematic diagram showing the disclosed invention, a 2×3 interferometer 900. The dashed box 902 comprises two inputs, 904 and 906, the interferometer which functions as a combiner and a splitter, and the three outputs, 908, 910, and 912, wherein one of the three outputs acts as a drop port. Altogether, this single component, as outlined by the dashed box 902, performs the function of those components outlined by the dashed box 802 in FIG. 8 and Paragraph [0068], above, whilst significantly decreasing the required area on a chip. The top output 908 comprises half of the out-of-phase combination of the two inputs. The drop port 910 comprises an in-phase combination of the two inputs. Finally, the bottom output 912 comprises the other half of the out-of-phase combination of the two inputs.

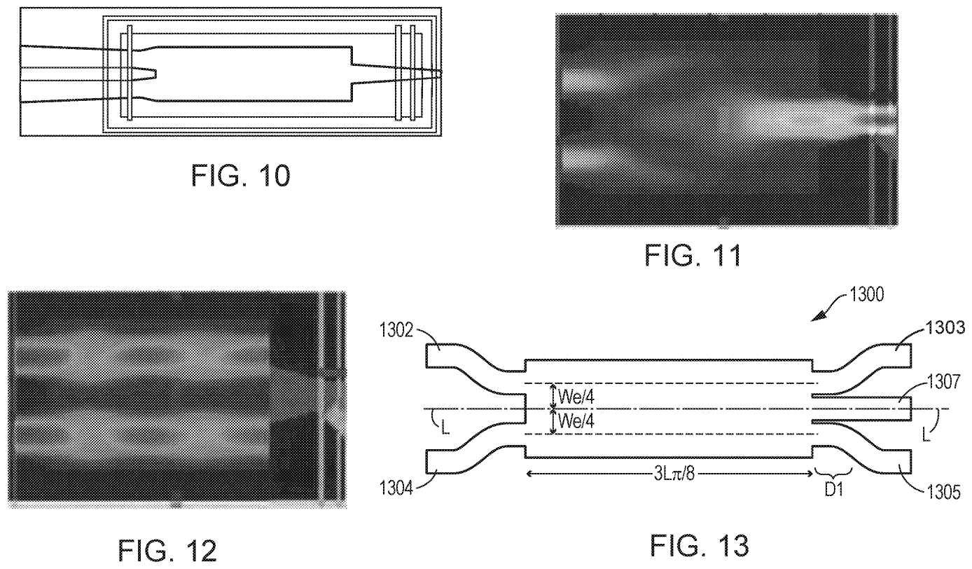

FIGS. 10-12, as described below, generally relate to conventional 2×1 MMIs, which are well-known components for splitters, combiners, and interferometers. However, FIG. 13 provides a novel 2×3 MMI for use within a tunable optical filter.

FIG. 10 is a schematic diagram showing a 2×1 multimode interferometer (MMI), as setup for a finite-difference time-domain (FDTD) simulation which models nano-scale optical devices. Light is incident from the left side of the MMI coupler.

FIG. 11 is an image showing the power density of two in-phase, equal-power inputs from the left of a conventional 2×1 MMI. FIG. 11 further illustrates a high power density TE0 mode beginning just after the midpoint of the conventional 2×1 MMI, which eventually turns into the TE0 output at the right. As shown in FIG. 11, the power density is the highest at the rightmost point of the conventional 2×1 MMI as it as output as a TE0 mode.

FIG. 12 is an image showing the power density for two out-of-phase (180°-shifted), equal-power inputs from the left of a 2×1 MMI. FIG. 12 further illustrates a high power density TE1 mode entering the conventional 2×1 MMI at the left, and the TE1 mode having three peak power densities throughout an interference propagation region. FIG. 12 further illustrates that the power density for the TE1 mode is truncated at the end of the interference propagation region.

The present disclosure makes extensive use of the terms “tapered input region” and “flared output region”. The purpose of this paragraph is to clearly identify these terms and provide a non-limiting definition as to which they are intended to be understood in the present disclosure. “Tapered input region” is meant to be understood as meaning a region whose inputs, or waveguides and waveguide cores, begin spread apart at an input region and slowly come within close proximity of one another towards a middle region, such as the presently disclosed narrow coupling region or interference propagation region. “Flared output region” is meant to be understood as meaning a region whose outputs, or waveguides and waveguide cores, begin within close proximity of one another at the end of a middle region, such as the presently disclosed narrow coupling region or interference propagation region, and gradually spread apart towards an output region.

FIG. 13 is a schematic diagram showing one aspect of the disclosed invention, a 2×3 MMI 1300, also referred to herein as a multimode interference optical coupler. As shown, the 2×3 MMI has three regions: a tapered input region, an interference propagation region, and a flared output region. The first region, a tapered input region, has two single-mode input waveguide cores, 1302 and 1304, that are separated by a width defined by Wₑ/2, where Wₑ is the effective width of the interference propagation region. The second region, an interference propagation region, which extends from the first region, acts as a multimode waveguide core with a multimode interference pattern to combine the light from each of the two input waveguide cores, 1302 and 1304, and eventually split the combined light amongst three output waveguide cores, 1303, 1305, and 1307, found in the third region. The third region, a flared output region, which extends from the second region, has three single-mode output waveguide cores that are separated by defined widths: the first output waveguide core 1303 and the third output waveguide core 1307 are separated by Wₑ/4, the third output waveguide core 1307 and the second output waveguide core 1305 are separated by Wₑ/4, and the first output waveguide core 1303 and the second output waveguide core 1305 are separated by Wₑ/2.

Additionally, the third output waveguide core 1307 defines a longitudinal axis, L, for which the tapered input region, the interference propagation region, and the flared output region are all symmetric about. As for the length of the interference propagation region of the presently disclosed 2×3 MMI, it is defined by 3L_{π}/8, where L_{π}is a beat length of two lowest order modes. That is, the exact length of the 2×3 MMI is substantial. In fact, this length is calculated such that light is coupled to the first, second, and third output waveguide cores most efficiently. If the length of the interference propagation region were different than the calculated length, then the 2×3 MMI would be acting inefficiently. Finally, a decoupling region is positioned between the interference propagation region and the flared output region which, if necessary, adiabatically separates spatially overlapping output modes.

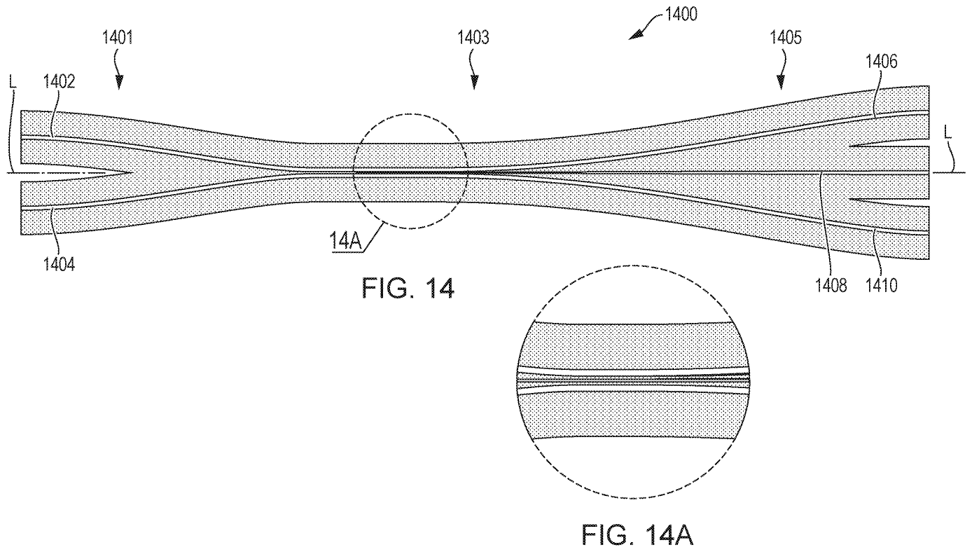

FIG. 14 is a schematic diagram showing one aspect of the disclosed invention, an adiabatic 2×3 coupler 1400, which comprises a tapered input region 1401, a narrow coupling region 1403, and a flared output region 1405. The tapered input region 1401 comprises a first waveguide core, whose input is 1402, and a second waveguide core, whose input is 1404. At this tapered input region 1401, the two waveguide cores are separated. However, the narrow coupling region 1403 brings these two waveguide cores in close proximity with one another and introduces a third waveguide core that is positioned between the first and second waveguide cores. This third waveguide core begins very narrow at the narrow coupling region and gradually increases in width towards the flared output region. This third waveguide core also defines a longitudinal axis, L, by which the adiabatic 2×3 coupler is symmetric about. Finally, the flared output region 1405 comprises the first waveguide core, whose output is 1406, the second waveguide core, whose output is 1410, and the third waveguide core, whose output is 1408. At this flared output region 1405, the three waveguide cores are separated.

The light entering the adiabatic 2×3 coupler 1400 via inputs 1402 and 1404 comprises an out-of-phase component and an in-phase component. The out-of-phase component is a TE1 mode while the in-phase combination component is a TE0 mode. The TE1 and TE0 modes both begin at the two input waveguide cores, whose inputs are 1402 and 1404, respectively, however, as light propagates through the adiabatic 2×3 coupler 1400, the TE0 mode is routed to the third waveguide core where it is then outputted at output 1408. The TE1 mode remains on the outer waveguides, or the first and second waveguide cores. As a result, power in the TE0 mode peaks along the longitudinal axis on the third waveguide core, while power in the TE1 mode peaks along the first and second waveguide cores which are located above and below the longitudinal axis. Thus, the TE1 mode has a null along the centerline, or the longitudinal axis.

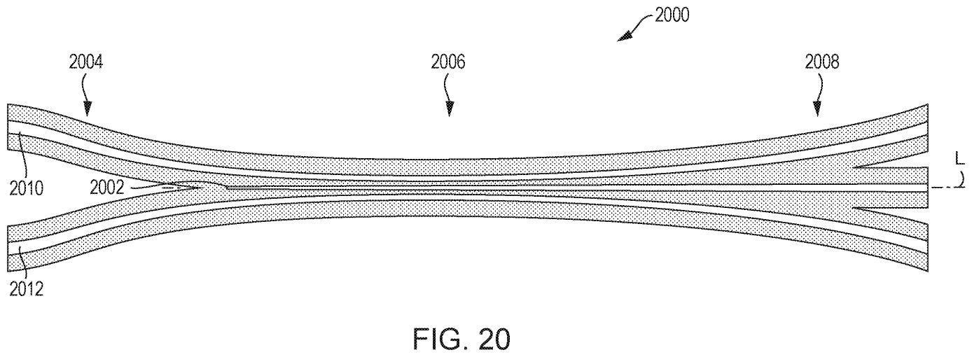

This design particularly takes advantage of mode symmetry. That is, the TE1 mode has a null in the centerline where the third waveguide core is located due to its odd symmetry. Several embodiments of the adiabatic 2×3 coupler 1400 are further identified and described in FIGS. 20-26 and Paragraphs [0087]-[0093]. This adiabatic implementation has several advantages including, but not limited to, low loss, wide bandwidth, low back reflection, and fabrication tolerance. It should be noted that the function of this adiabatic 2×3 coupler can also be implemented not only with adiabatic devices, but also with interferometric devices, or those that combine adiabatic and interferometric principles.

It should be noted that in some embodiments, the waveguide cores disclosed above, and as shown, are rib waveguides surrounded by a partially etched waveguide layer referred to herein as a slab region. At the tapered input region, the first waveguide core and the second waveguide core are surrounded by their own respective slab portions. However, as these two waveguide cores come within close proximity of one another, and as the third waveguide core is introduced, the individual slab portions join together and the three waveguide cores share a single slab portion in the narrow coupling region. Finally, as these three waveguide cores separate towards the flared output region, they each develop their own respective slab portions. That is, the first waveguide core, the second waveguide core, and the third waveguide core all become surrounded by their own respective slab portions as the waveguide cores reach the flared output region.

For added transparency and clarification, FIG. 14A provides a magnified view of the narrow coupling region 1403 of the adiabatic 2×3 coupler 1400 of FIG. 14 such that the first waveguide core, the second waveguide core, and the third waveguide core can be easily seen in the narrow coupling region.

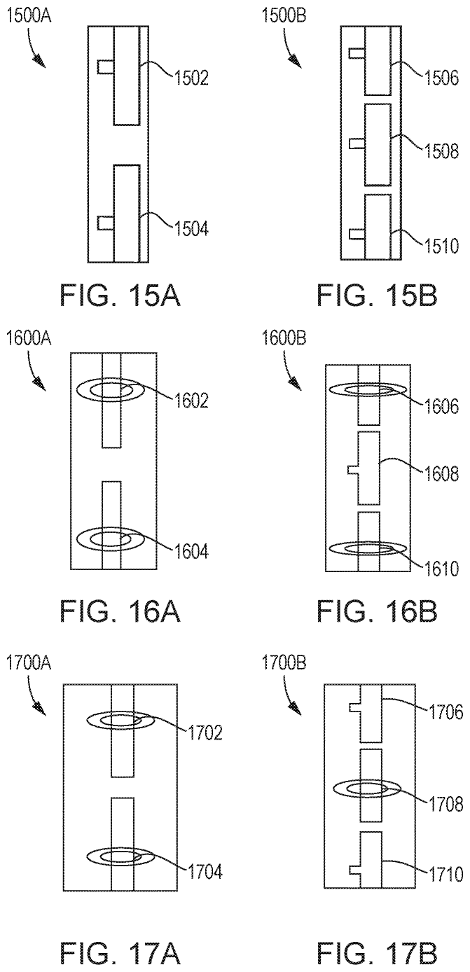

FIGS. 15A-B are schematic diagrams showing the left end 1500A of a 2×3 interferometer and the right end 1500B of a 2×3 interferometer. FIGS. 15A-B further show the two inputs, or waveguide cores, 1502 and 1504, and the three outputs, or waveguide cores, 1506, 1508, and 1510, of a 2×3 interferometer. Furthermore, the two inputs, 1502 and 1504, and the three outputs, 1506, 1508, and 1510, illustrate a rib waveguide. As shown, each waveguide core, 1502, 1504, 1506, 1508, and 1510 comprises a protruding portion referred to herein as a rib. The thinner part of the core that is above and below the rib is referred to herein as a slab. The key takeaway is light is centered in the rib, which is discussed in greater detail below.

FIGS. 16A-B are schematic diagrams showing the left end 1600A of a 2×3 interferometer and the right end 1600B of a 2×3 interferometer. FIGS. 16A-B further show the two inputs, or waveguide cores, 1602 and 1604, and the three outputs, or waveguide cores, 1606, 1608, and 1610, of a 2×3 interferometer. Similar to FIGS. 15A-B, FIG. 16B illustrates a rib waveguide, as shown by waveguide core 1608. While not shown, it is important to note that waveguide cores 1602, 1604, 1606, and 1610 also comprise a rib similar to waveguide core 1608. Furthermore, FIGS. 16A-B show, by use of contour lines, that the TE1 mode stays on the outer waveguides, or the first and second waveguide cores, during the propagation of light from an input to an output. That is, at the right end 1600B of a 2×3 interferometer, the TE1 mode is found on the outer waveguides, or the first and second waveguide cores (i.e., outputs 1606 and 1610). Similarly, a cross-sectional view at any point in the narrow coupling region would also show that the TE1 mode stays on the outer waveguides, or the first and second waveguide cores. However, one would notice that the TE1 modes come close together, with a null along the centerline, as the outer waveguides, or the first and second waveguide cores, come into close proximity with one another in the narrow coupling region.

FIGS. 17A-B are schematic diagrams showing the left end 1700A of a 2×3 interferometer and the right end 1700B of a 2×3 interferometer. FIGS. 17A-B further show the two inputs, or waveguide cores, 1702 and 1704, and the three outputs, or waveguide cores, 1706, 1708, and 1710, of a 2×3 interferometer. Similar to FIGS. 15A-B and FIG. 16B, FIG. 17B illustrates a rib waveguide, as shown by waveguide cores 1706 and 1710. While not shown, it is important to note that waveguide cores 1702, 1704, and 1708 also comprise a rib similar to waveguide cores 1706 and 1710. Furthermore, FIGS. 17A-B show, by use of contour lines, that the TE0 mode is routed to the center waveguide, or the third waveguide core, during the propagation of light from an input to an output. That is, at the right end 1700B of a 2×3 interferometer, the TE0 mode is found on the center waveguide, or the third waveguide core (i.e., output 1708). Similarly, a cross-sectional view at any point in the narrow coupling region would show that the TE0 mode couples to the center waveguide, or the third waveguide core, and remains on the center waveguide, or the third waveguide core, towards the output.

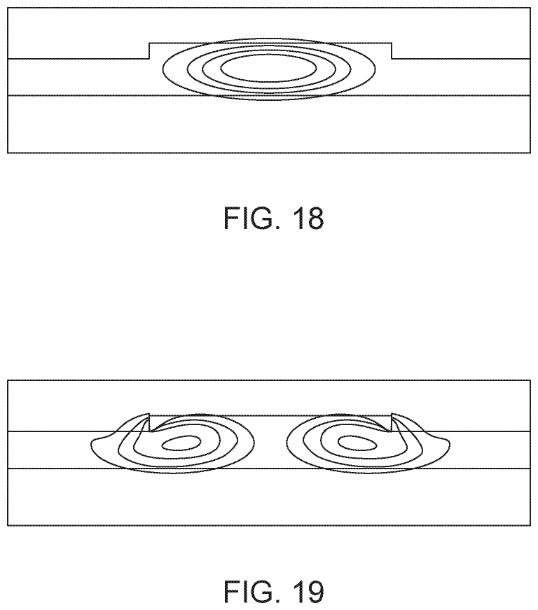

FIG. 18 is a schematic diagram illustrating an example TE0 mode. By use of contour lines, FIG. 18 shows that the TE0 mode's intensity peaks along a centerline. It should be noted that FIG. 18 does not represent a combination of mode shape (i.e., contour lines) and waveguide boundaries (i.e., horizontal/vertical lines) in the present disclosure. Rather, FIG. 18 is merely an example to illustrate the concept of a TE0 mode.

FIG. 19 is a schematic diagram illustrating an example TE1 mode. By use of contour lines, FIG. 19 shows that the TE1 mode's intensity does not peak along the centerline and instead comprises a null in the centerline. It should be noted that FIG. 19 does not represent a combination of mode shape (i.e., contour lines) and waveguide boundaries (i.e., horizontal/vertical lines) in the present disclosure. Rather, FIG. 19 is merely an example to illustrate the concept of a TE1 mode.

FIG. 20 is a schematic diagram showing an adiabatic 2×3 coupler 2000, wherein the center waveguide, or third waveguide core, 2002 begins narrow at the tapered input region 2004 and widens to the flared output region 2008 and wherein the outer waveguides, or first and second waveguide cores, 2010 and 2012 begin wide at the tapered input region 2004, narrow in the narrow coupling region 2006, and widen to the flared output region 2008, according to at least one embodiment of the present disclosure. Now, with specific reference to the narrow coupling region 2006, the adiabatic 2×3 coupler 2000 is vertically symmetric about a longitudinal axis, L, defined by the center waveguide, or third waveguide core, and comprises two outer waveguides, or a first and second waveguide core, 2010 and 2012, that fan-in to the narrow coupling region and become within close proximity of one another as well as the center waveguide, or third waveguide core, 2002. Following the narrow coupling region 2006, the outer waveguides, or first and second waveguide cores, 2010 and 2012, fan-out to the flared output region 2008. An initial implementation is a partially etched silicon waveguide on a silicon-on-insulator wafer, however it should be noted that the disclosed invention may have a number of

### Other Implementations.

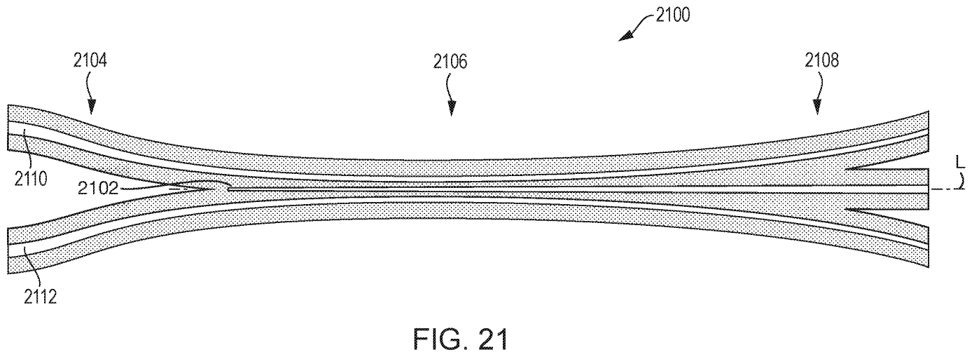

FIG. 21 is a schematic diagram showing an adiabatic 2×3 coupler 2100, wherein the center waveguide, or third waveguide core, 2102 begins narrow at the tapered input region 2104 and widens to the flared output region 2108 and wherein the outer waveguides, or first and second waveguide cores, 2110 and 2112 begin wide at the tapered input region 2104, narrow in the narrow coupling region 2106, and remain narrow to the flared output region 2108, according to at least one embodiment of the present disclosure. Now, with specific reference to the narrow coupling region 2106, the adiabatic 2×3 coupler 2100 is vertically symmetric about a longitudinal axis, L, defined by the center waveguide, or third waveguide core, and comprises two outer waveguides, or first and second waveguide cores, 2110 and 2112, that fan-in to the narrow coupling region and become within close proximity of one another as well as the center waveguide, or third waveguide core, 2102. Following the narrow coupling region 2106, the outer waveguides, or first and second waveguide cores, 2110 and 2112, fan-out to the flared output region 2108. An initial implementation is a partially etched silicon waveguide on a silicon-on-insulator wafer, however it should be noted that the disclosed invention may have a number of other implementations.

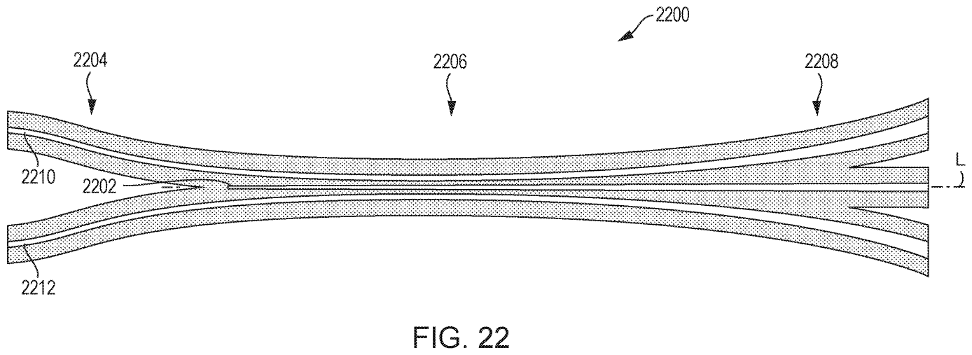

FIG. 22 is a schematic diagram showing an adiabatic 2×3 coupler 2200, wherein the center waveguide, or third waveguide core, 2202 begins narrow at the tapered input region 2204 and widens to the flared output region 2208 and wherein the outer waveguides, or first and second waveguide cores, 2210 and 2212 begin narrow at the tapered input region 2204, remain narrow in the narrow coupling region 2206, and widen to the flared output region 2208, according to at least one embodiment of the present disclosure. Now, with specific reference to the narrow coupling region 2206, the adiabatic 2×3 coupler 2200 is vertically symmetric about a longitudinal axis, L, defined by the center waveguide, or third waveguide core, and comprises two outer waveguides, or first and second waveguide cores, 2210 and 2212, that fan-in to the narrow coupling region and become within close proximity of one another as well as the center waveguide, or third waveguide core, 2202. Following the narrow coupling region 2206, the outer waveguides, or first and second waveguide cores, 2210 and 2212, fan-out to the flared output region 2208. An initial implementation is a partially etched silicon waveguide on a silicon-on-insulator wafer, however it should be noted that the disclosed invention may have a number of other implementations.

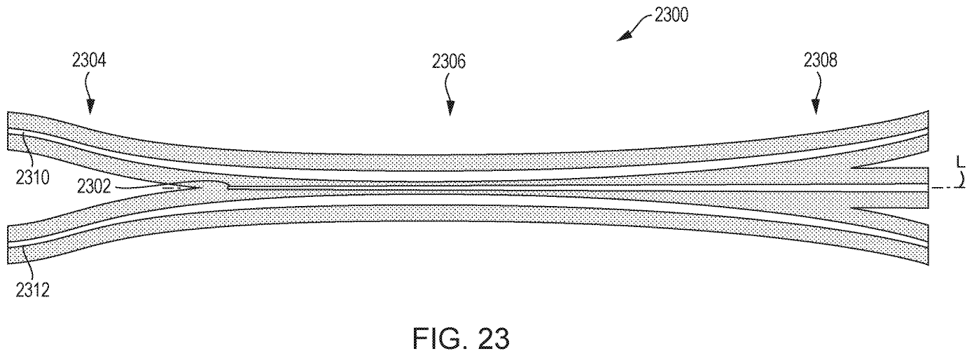

FIG. 23 is a schematic diagram showing an adiabatic 2×3 coupler 2300, wherein the center waveguide, or third waveguide core, 2302 begins narrow at the tapered input region 2304 and widens to the flared output region 2308 and wherein the outer waveguides, or first and second waveguide cores, 2310 and 2312 begin narrow at the tapered input region 2304, widen in the narrow coupling region 2306, and narrow to the flared output region 2308, according to at least one embodiment of the present disclosure. Now, with specific reference to the narrow coupling region 2306, the adiabatic 2×3 coupler 2300 is vertically symmetric about a longitudinal axis, L, defined by the center waveguide, or third waveguide core, and comprises two outer waveguides, or first and second waveguide cores, 2310 and 2312, that fan-in to the narrow coupling region and become within close proximity of one another as well as the center waveguide, or third waveguide core, 2302. Following the narrow coupling region 2306, the outer waveguides, or first and second waveguide cores, 2310 and 2312, fan-out to the flared output region 2308. An initial implementation is a partially etched silicon waveguide on a silicon-on-insulator wafer, however it should be noted that the disclosed invention may have a number of other implementations.

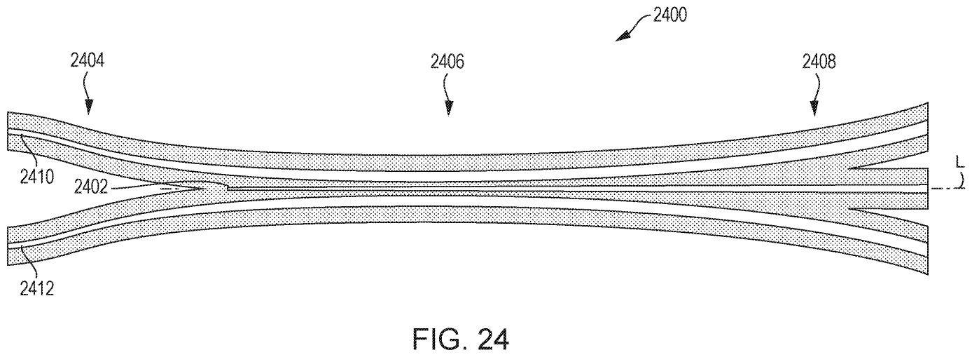

FIG. 24 is a schematic diagram showing an adiabatic 2×3 coupler 2400, wherein the center waveguide, or third waveguide core, 2402 begins narrow at the tapered input region 2404 and widens to the flared output region 2408 and wherein the outer waveguides, or first and second waveguide cores, 2410 and 2412 begin narrow at the tapered input region 2404, widen in the narrow coupling region 2406, and remain widened to the flared output region 2408, according to at least one embodiment of the present disclosure. Now, with specific reference to the narrow coupling region 2406, the adiabatic 2×3 coupler 2400 is vertically symmetric about a longitudinal axis, L, defined by the center waveguide, or third waveguide core, and comprises two outer waveguides, or first and second waveguide cores, 2410 and 2412, that fan-in to the narrow coupling region and become within close proximity of one another as well as the center waveguide, or third waveguide core, 2402. Following the narrow coupling region 2406, the outer waveguides, or first and second waveguide cores, 2410 and 2412, fan-out to the flared output region 2408. An initial implementation is a partially etched silicon waveguide on a silicon-on-insulator wafer, however it should be noted that the disclosed invention may have a number of other implementations.

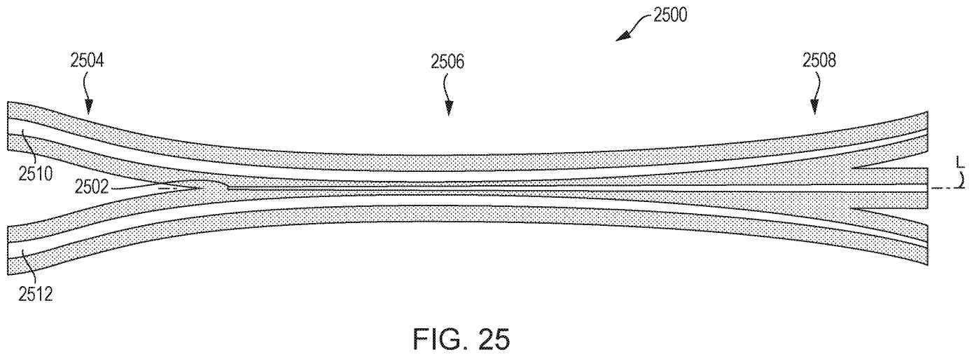

FIG. 25 is a schematic diagram showing an adiabatic 2×3 coupler 2500, wherein the center waveguide, or third waveguide core, 2502 begins narrow at the tapered input region 2504 and widens to the flared output region 2508 and wherein the outer waveguides, or first and second waveguide cores, 2510 and 2512 begin wide at the tapered input region 2504, remain wide in the narrow coupling region 2506, and narrow to the flared output region 2508, according to at least one embodiment of the present disclosure. Now, with specific reference to the narrow coupling region 2506, the adiabatic 2×3 coupler 2500 is vertically symmetric about a longitudinal axis, L, defined by the center waveguide, or third waveguide core, and comprises two outer waveguides, or first and second waveguide cores, 2510 and 2512, that fan-in to the narrow coupling region and become within close proximity of one another as well as the center waveguide, or third waveguide core, 2502. Following the narrow coupling region 2506, the outer waveguides, or first and second waveguide cores, 2510 and 2512, fan-out to the flared output region 2508. An initial implementation is a partially etched silicon waveguide on a silicon-on-insulator wafer, however it should be noted that the disclosed invention may have a number of other implementations.

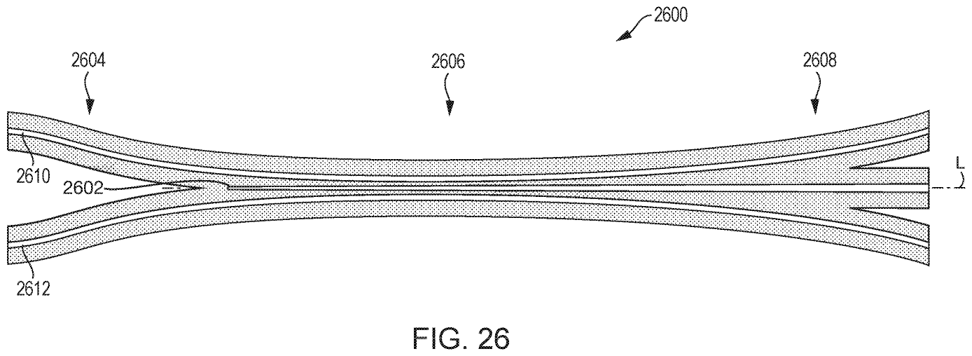

FIG. 26 is a schematic diagram showing an adiabatic 2×3 coupler 2600, wherein the center waveguide, or third waveguide core, 2602 begins narrow at the tapered input region 2604 and widens to the flared output region 2608 and wherein the outer waveguides, or first and second waveguide cores, 2610 and 2612 remain uniform from the tapered input region 2604 to the flared output region 2608, according to at least one embodiment of the present disclosure. Now, with specific reference to the narrow coupling region 2606, the adiabatic 2×3 coupler 2600 is vertically symmetric about a longitudinal axis, L, defined by the center waveguide, or third waveguide core, and comprises two outer waveguides, or first and second waveguide cores, 2610 and 2612, that fan-in to the narrow coupling region and become within close proximity of one another as well as the center waveguide, or third waveguide core, 2602. Following the narrow coupling region 2606, the outer waveguides, or first and second waveguide cores, 2610 and 2612, fan-out to the flared output region 2608. An initial implementation is a partially etched silicon waveguide on a silicon-on-insulator wafer, however it should be noted that the disclosed invention may have a number of other implementations.

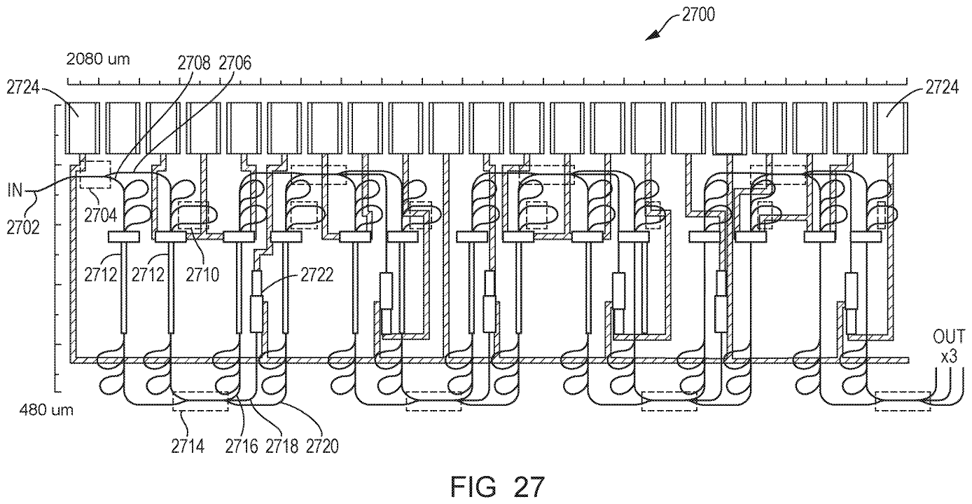

FIG. 27 is a schematic diagram showing one aspect of the disclosed invention, a tunable optical filter system 2700, comprising several MZI filter stages cascaded in series with one another and folded using 90-degree bends to reduce the overall required area on a chip by constructing a compact tunable optical filter. In this system, light first enters the filter along the single system input line IN 2702. The light then travels through a 1×2 input coupler 2704, which takes the light from the single input line IN 2702 and generates a first system input and a second system input which act as the inputs for a first MZI filter stage. The first system input and the second system input then flow along two separate paths, a first path 2706 and a second path 2708, respectively. The light propagates along the two paths and propagates a different distance on the two paths due to the path length unequal region 2710. Next, the light continues to flow along the first and second paths, which crosses under phase shifters 2712 that are placed over the first and second paths. These phase shifters may be, but are not limited to, waveguide heaters. The light then flows, from the first path 2706 and the second path 2708, into the presently disclosed 2×3 interferometer 2714 as a first input and a second input, respectively. After passing through the 2×3 interferometer, the light is output along the at least one of three outputs, 2716, 2718, and 2720, wherein the first and second outputs 2716 and 2720 act as the previously disclosed first and second waveguide cores, respectively, and the third output 2718 acts as the previously disclosed third waveguide core. The first and second outputs 2716 and 2720 are through ports wherein the first output 2716 is the top through port comprising half of the out-of-phase combination of inputs and wherein the second output 2720 is the bottom through port comprising the other half of the out-of-phase combination of inputs. The third output 2718 is sent to a monitor photodiode 2722 to monitor and control the phases of transmitted light, and wherein the monitor photodiode 2722, among other components, is connected to the electrical contact pads 2724 found in close proximity to the plurality of MZI filter stages. Finally, the first and second outputs 2716 and 2720 form the basis of the two inputs for the subsequent MZI filter stage.

The above disclosed process repeats itself for a number of MZI filter stages until a final MZI filter stage is reached. Once the final MZI filter stage is reached, the process continues as previously disclosed, however, once the 2×3 interferometer of the final MZI filter stage is reached, the system simply outputs all three outputs from the system rather than generating two inputs for a subsequent MZI filter stage and sending the third output to a monitor photodiode.

In this example system implementation, there were seven total cascaded MZI filter stages, however, it should be noted that the above disclosed FIG. 27 is simply a representation of how multiple MZI filter stages are cascaded to construct a tunable optical filter and should not be construed as limiting the number of MZI filter stages per optical filter to seven.

Additionally, it should be noted that in the above disclosed tunable optical filter system, the disclosed 2×3 interferometer may be either of the previously disclosed 2×3 MMI in FIG. 13, Paragraphs [0075]-[0076] and the previously disclosed adiabatic 2×3 coupler in FIGS. 14-14A, Paragraphs [0077]-[0081].

Having thus described several aspects and embodiments of the technology of this application, it is to be appreciated that various alterations, modifications, and improvements will readily occur to those of ordinary skill in the art. Such alterations, modifications, and improvements are intended to be within the scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

In most embodiments, a processor may be a physical or virtual processor. In other embodiments, a virtual processor may be spread across one or more portions of one or more physical processors. In certain embodiments, one or more of the embodiments described herein may be embodied in hardware such as a Digital Signal Processor (DSP). In certain embodiments, one or more of the embodiments herein may be executed on a DSP. One or more of the embodiments herein may be programmed into a DSP. In some embodiments, a DSP may have one or more processors and one or more memories. In certain embodiments, a DSP may have one or more computer readable storages. In many embodiments, a DSP may be a custom designed ASIC chip. In other embodiments, one or more of the embodiments stored on a computer readable medium may be loaded into a processor and executed.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. The transitional phrases “consisting of” and “consisting essentially of” shall be closed or semi-closed transitional phrases, respectively.

Where a range or list of values is provided, each intervening value between the upper and lower limits of that range or list of values is individually contemplated and is encompassed within the disclosure as if each value were specifically enumerated herein. In addition, smaller ranges between and including the upper and lower limits of a given range are contemplated and encompassed within the disclosure. The listing of exemplary values or ranges is not a disclaimer of other values or ranges between and including the upper and lower limits of a given range.

The use of headings and sections in the application is not meant to limit the disclosure; each section can apply to any aspect, embodiment, or feature of the disclosure. Only those claims which use the words “means for” are intended to be interpreted under 35 USC 112(f). Absent a recital of “means for” in the claims, such claims should not be construed under 35 USC 112. Limitations from the specification are not intended to be read into any claims, unless such limitations are expressly included in the claims.

Embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a computer program product embodied in one or more computer readable medium(s) having computer readable program code embodied thereon.

What is claimed is:

1. An adiabatic optical coupler, comprising:
a tapered input region comprising a first waveguide core and a second waveguide core separated by a distance;
a narrow coupling region extending from the tapered input region, wherein the first waveguide core and the second waveguide core are brought into close proximity, and wherein a third waveguide core is positioned between the first waveguide core and the second waveguide core, the third waveguide core defining a longitudinal axis; and
a flared output region extending from the narrow coupling region, wherein the first waveguide core, the second waveguide core, and the third waveguide core are separated.

2. The adiabatic optical coupler of claim 1, wherein light entering the first waveguide core and the second waveguide core at the tapered input region comprises a TE0 mode (in-phase) component and a TE1 mode (out-of-phase) component.

3. The adiabatic optical coupler of claim 2, wherein during a propagation of light, the TE0 mode (in-phase) component is routed to the third waveguide core and the TE1 mode (out-of-phase) component remains on the first waveguide core and the second waveguide core.

4. The adiabatic optical coupler of claim 2, wherein the narrow coupling region, power in the TE0 mode peaks along the longitudinal axis aligning with the third waveguide core, and power in the TE1 mode has a null along the longitudinal axis aligning with the third waveguide core and has two peaks above and below the longitudinal axis aligning with the first waveguide core and the second waveguide core.

5. The adiabatic optical coupler of claim 1, wherein the tapered input region, the narrow coupling region, and the flared output region are symmetric about the longitudinal axis.

6. The adiabatic optical coupler of claim 1, wherein the third waveguide core widens as it extends from the narrow coupling region to the flared output region.

7. The adiabatic optical coupler of claim 1, wherein the first waveguide core is a rib surrounded by a first slab portion and the second waveguide core is a rib surrounded by a second slab portion at the tapered input region; wherein the first waveguide core, the second waveguide core, and the third waveguide core are surrounded by a single slab portion at the narrow coupling region; and wherein the first waveguide core is surrounded by a first slab portion, the second waveguide core is surrounded by a second slab portion, and the third waveguide core is a rib surrounded by a third slab portion at the flared output region.

8. A multimode interference optical coupler, comprising:
a tapered input region comprising a first input waveguide core and a second input waveguide core separated by a distance;
an interference propagation region extending from the tapered input region; and
a flared output region extending from the interference propagation region;
wherein the interference propagation region acts as a multimode waveguide core to combine light from the first input waveguide core and the second input waveguide core;
wherein the flared output region comprises a plurality of output waveguides comprising a first output waveguide core, a second output waveguide core, and a third output waveguide core;
wherein the third output waveguide core defines a longitudinal axis; and
wherein the interference propagation region has a length calculated to efficiently couple the light from the multimode waveguide core into the first output waveguide core, the second output waveguide core, and the third output waveguide core.

9. The multimode interference optical coupler of claim 8, wherein the interference propagation region has a length defined by 3L_{π}/8, wherein L_{π}is a beat length of two lowest order modes.

10. The multimode interference optical coupler of claim 8, wherein the first output waveguide core and the third output waveguide core are separated by a width defined by Wₑ/4, wherein Wₑ is an effective width of the interference propagation region, the third output waveguide core and the second output waveguide core are separated by a width defined by Wₑ/4, and the first input waveguide core and the second input waveguide core are separated by a width defined by Wₑ/2.

11. The multimode interference optical coupler of claim 8, wherein the first input waveguide core and the second input waveguide core are single-mode inputs, wherein the interference propagation region comprises a multimode interference pattern, and wherein the first output waveguide core, the second output waveguide core, and the third output waveguide core are single-mode outputs.

12. The multimode interference optical coupler of claim 8, comprising a decoupling region positioned between the interference propagation region and the flared output region to adiabatically separate spatially overlapping output modes.

13. The multimode interference optical coupler of claim 8, wherein the tapered input region, the interference propagation region, and the flared output region are symmetric about the longitudinal axis.

14. A tunable optical filter system, comprising:
a system input;
a 1×2 input coupler, wherein the 1×2 input coupler receives light from the system input and splits the light into a first system input and a second system input;
a plurality of Mach-Zehnder interferometer (MZI) filter stages cascaded in series, each MZI filter stage comprising:
a first path comprising a first path length;
a second path comprising a second path length, wherein the second path length is greater than the first path length; and
a 2×3 interferometer, wherein the 2×3 interferometer receives light from a first input and a second input, combines the light from the first input and the second input interferometrically into an in-phase combination and an out-of-phase combination, and outputs half of the out-of-phase combination to a first output, the other half of the out-of-phase combination to a second output, and the in-phase combination to a third output;
wherein, a first MZI filter stage, the first path receives light from the first system input and the second path receives light from the second system input, and wherein, any MZI filter stage subsequent to the first MZI filter stage, the first path receives light from the first output of a preceding MZI filter stage and the second path receives light from the second output of the preceding MZI filter stage; and
a system output, wherein the system output comprises the first output, the second output, and the third output of a final MZI filter stage.

15. The tunable optical filter system of claim 14, wherein the 2×3 interferometer is an adiabatic optical coupler, comprising:
a tapered input region comprising a first waveguide core and a second waveguide core separated by a distance;
a narrow coupling region extending from the tapered input region, wherein the first waveguide core and the second waveguide core are brought into close proximity, and wherein a third waveguide core is positioned between the first waveguide core and the second waveguide core, the third waveguide core defining a longitudinal axis; and
a flared output region extending from the narrow coupling region, wherein the first waveguide core, the second waveguide core, and the third waveguide core are separated.

16. The tunable optical filter system of claim 14, wherein the 2×3 interferometer is a multimode interference optical coupler, comprising:
a tapered input region comprising a first input waveguide core and a second input waveguide core separated by a distance;
an interference propagation region extending from the tapered input region; and
a flared output region extending from the interference propagation region;
wherein the interference propagation region acts as a multimode waveguide core to combine light from the first input waveguide core and the second input waveguide core;
wherein the flared output region comprises a plurality of output waveguides comprising a first output waveguide core, a second output waveguide core, and a third output waveguide core;
wherein the third output waveguide core defines a longitudinal axis; and
wherein the interference propagation region has a length calculated to efficiently couple the light from the multimode waveguide core into the first output waveguide core, the second output waveguide core, and the third output waveguide core.

17. The tunable optical filter system of claim 14, wherein the tunable optical filter further comprises at least one of a first phase shifter positioned over the first path and a second phase shifter positioned over the second path.

18. The tunable optical filter system of claim 14, wherein the third output transmits light to a monitor photodiode, and wherein the monitor photodiode is used to monitor and control phases of the transmitted light.

19. The tunable optical filter system of claim 14, wherein the tunable optical filter further comprises a plurality of electrical contact pads positioned in close proximity to the plurality of MZI filter stages cascaded in series.

20. The tunable optical filter system of claim 14, wherein the plurality of MZI filter stages cascaded in series further comprise 90-degree bends to reduce a required area on a chip.
